(19) United States
(12) Patent Application Publication
(10) Pub. No.: US 2012/0245780 A1
(43) Pub. Date: Sep. 27, 2012

(54) MOTOR VEHICLE CONTROL SYSTEM

(75) Inventors: Markus Eisele, Friedrichshafen (DE); Benjamin Winkler, Ludwigsburg (DE); Yvonne Wiegand, Kressbronn (DE)

(73) Assignee: ZF FRIEDRICHSHAFEN AG, Friedrichshafen (DE)

(21) Appl. No.: 13/502,180

(22) PCT Filed: Nov. 4, 2010
(86) PCT No.: PCT/EP10/66773

§ 371 Date: Jun. 1, 2012

(30) Foreign Application Priority Data
Nov. 19, 2009 (DE) 10 2009 046 860.9

(51) Int. Cl. B60W 20/00; B60W 10/08; B60W 10/06

(52) U.S. Cl. 701/22; 180/65.265; 903/930

(57) ABSTRACT

A motor vehicle control system for a vehicle with a hybrid drive in which first control units, namely, a control unit for each of an internal combustion engine, a transmission, and a hybrid management control unit, are connected to a first data bus. Second control units, namely, at least the hybrid management control unit and further control units of an electric motor portion of the drive-train are connected to the second data bus. Only a single one of the control units connected to the second data bus, holds application data centrally for the hybrid management control unit and, for all the other control units of the electric motor portion of the drive-train, in order for supplying the same with application-dependent data, in contrast the other control units of the electric motor portion, in themselves and without receiving data from the control unit, exclusively contain application-independent program data.

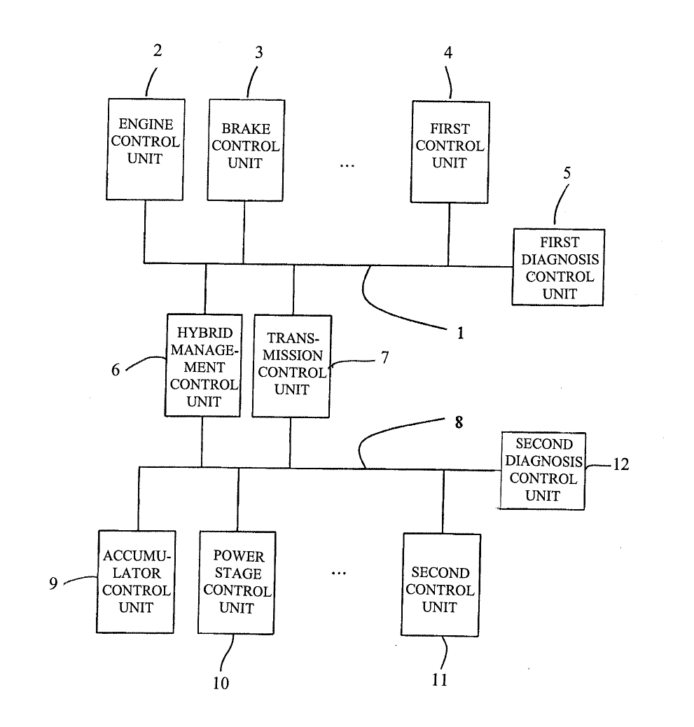

This application is a National Stage completion of PCT/EP2010/066773 filed Nov. 4, 2010, which claims priority from German patent application serial no. 10 2009 046 860.9 filed Nov. 19, 2009.

### FIELD OF THE INVENTION

The invention concerns a motor vehicle control system for a motor vehicle having a hybrid drive comprising an internal combustion engine and an electric machine.

### BACKGROUND OF THE INVENTION

In conventional motor vehicles which comprise exclusively an internal combustion engine as their drive aggregate, all the control units of the motor vehicle are connected to at least one common data bus, such that the control units send and/or receive data by way of the, or each common data bus. This data bus is also called a CAN data bus. In this context the control units connected to the, or to each common data bus are in particular an engine control unit, a transmission control unit, a diagnostic control unit, a brake management control unit and a control unit for regulating the driving speed.

In modern motor vehicles, which comprise as their drive aggregate a hybrid drive with an internal combustion engine and an electric machine, in addition to the control units present in conventional motor vehicles further control units are present, namely ones associated with the electric motor portion of the drive-train. The control units associated with the electric motor drive-train portion are connected to at least one second common data bus, also called the hybrid CAN data bus, and these control units send and/or receive data by way of the second data bus.

The control units of a motor vehicle contain on the one hand program data and on the other hand application data, such that the program data consist of static, application-independent data and the application data consist of dynamic, application-dependent data.

In motor vehicle control systems known from the prior art, for each control unit of the motor vehicle control system a so-termed specification catalog at least of the application-dependent data has to be maintained and managed in each control unit, so that if, for example due to a defect, a control unit has to be replaced, a control unit supplied with corresponding application data must be kept ready.

Thus, in motor vehicle control systems known from the prior art the application-dependent data are supplied individually to each control unit of the motor vehicle control system, and this entails enormous effort and complexity for the management and maintenance of data in the individual control units of the motor vehicle control system. Moreover, since the various control units of the motor vehicle control system have to co-operate with each other perfectly, then in addition, if individual data management is taking place in each control unit of the motor vehicle control system, an enormous logistical effort is entailed in combining the individual control units to form the motor vehicle control system, since the only control units that can be combined to form a motor vehicle control system are those which are compatible in relation to their application data supply.

A consequence of this, an enormous variety of control unit variants have to be kept supplied with different application-dependent data, in order to ensure proper co-ordination of the control units in a motor vehicle control system over the lifetime of the motor vehicle.

### SUMMARY OF THE INVENTION

Starting from there, the present invention addresses the problem of providing a new type of motor vehicle control system for a motor vehicle with a hybrid drive.

That problem is solved by a motor vehicle control system according to the invention in which a single one of the control units connected to the second data bus holds centrally application data for the hybrid management control unit and all the other control units of the electric motor portion of the drive-train and supplies those control units with application-dependent data, whereas in contrast the other control units of the electric motor portion of the drive-train not supplied with data from the control unit contain, as such, only application-independent, program data.

In the motor vehicle control system according to the invention, exclusively one control unit in the electric motor portion of the drive-train contains application-dependent application data. All other control units of the electric motor portion of the drive-train, which together with the control unit containing application data are connected to the second data bus, contain in themselves only application-independent program data. The application-dependent data are supplied to these control units by the control unit of the electric motor drive-train portion which performs the central application data management.

In this way it is ensured that a specification catalog with application-dependent data only has to be managed and maintained in a single control unit of the electric motor portion of the drive-train. If then a control unit has to be exchanged owing to a defect, an application-independent control unit can be connected to the motor vehicle control system, which then obtains its application-dependent application data from the control unit responsible for the central application data management. Thus, on the one hand the effort of data maintenance in the control units of a motor vehicle control system can be reduced, and on the other hand the number of control unit variants that have to be available can also be reduced.

### BRIEF DESCRIPTION OF THE DRAWINGS

Preferred further developments of the invention emerge from the description presented below. An example embodiment of the invention, to which it is not limited, is explained in more detail with reference to the sole drawing, which shows a block diagram to make clear the motor vehicle control system according to the invention.

### DETAILED DESCRIPTION OF THE PREFERRED EMBODIMENTS

The present invention concerns a motor vehicle control system for a motor vehicle with a hybrid drive. A hybrid drive comprises an internal combustion engine, an electric machine and an electrical energy accumulator, such that the electric machine of the hybrid drive can be operated as a motor and as a generator. When operating as a motor the electric machine discharges the energy accumulator and converts electrical energy into mechanical energy. Conversely, when operating as a generator the electric machine charges the energy accumulator, converting mechanical energy into electrical energy.

The FIGURE shows the basic structure of a motor vehicle control system for a motor vehicle with a hybrid drive, wherein first control units 2, 3, 4 and 5 are connected to a first data bus 1. The control units 2, 3, 4 and 5 are control units that can just as well be present in motor vehicles with a conventional drive, such as an engine control unit 2 for controlling and/or regulating an internal combustion engine, a brake management control unit 3 for controlling and/or regulating braking processes, a control unit 4 for regulating the driving speed and a first diagnosis control unit 5.

The control units 2, 3, 4 and 5 send and/or receive data by way of the first data bus 1.

Besides the first control units 2, 3, 4 and 5 the control unit structure shown in the FIGURE also comprises a hybrid management control unit 6, which is also connected to the first data bus 1 and sends and/or receives data by way of the first data bus 1. Furthermore, the control unit structure of the FIGURE comprises a transmission control unit 7 which is also connected to the first data bus 1 and sends and/or receives data by way of the first data bus 1.

According to the FIGURE second control units 9, 10, 11 and 12 are subordinated to the hybrid management control unit 6 which is connected to the first data bus 1, such that for this purpose the hybrid management control unit 6 and the second control units 9, 10, 11 and 12 are connected to a second data bus 8. The FIGURE shows that the transmission control unit 7 is also connected to the second data bus 8. The control units 6, 7, 9, 10, 11 and 12 send and/or receive data by way of the second data bus 8. However, the control units 9, 10, 11 and 12 are subordinated exclusively to the hybrid management control unit 6 and not to the transmission control unit 7. The control units 9, 10, 11 and 12 subordinated to the hybrid management control unit 6 thus exchange data exclusively with the hybrid management control unit 6 but not with the transmission control unit 7.

The control units 9, 10, 11, 12 connected to the second data bus 8 and subordinated to the hybrid management control unit 6 are control units associated with the electric motor portion of the drive-train of the motor vehicle, which serve in particular to control and/or regulate the electric motor portion of the drive-train. Thus, the control unit 9 can be a control unit of an electrical energy accumulator of the hybrid drive. The control unit 10 can be a control unit of a power stage of the electric machine. The control unit 11 can be a control unit of a retarder. The control unit 12 is a second diagnosis control unit.

The hybrid management control unit 6, which is connected on the one hand to the first data bus 1 and on the other hand to the second data bus 8, serves as the central interface for data exchange between the first data bus 1 and the second data bus 8. The hybrid management control unit 6 converts protocols and/or contents of the data between the first data bus 1 and the second data bus 8.

According to the invention, only a single one of the control units connected to the second data bus 8 holds centrally application data for the hybrid management control unit 6 and all the other control units 9, 10, 11 and 12 of the electric motor portion of the drive-train, for the application-dependent supply of data to these control units 6, 9, 10, 11 and 12, whereas in contrast the other control units of the electric motor drive-train portion, in their own right and unless supplied with data from the control unit that holds the application data centrally, contain exclusively application-independent program data.

Preferably, the hybrid management control unit 6 performs the task of holding centrally the application data for the hybrid management control unit 6 itself and for all the control units 9, 10, 11 and 12 connected to the second data bus 8 of the electric motor portion of the drive-train of the motor vehicle, but not for the transmission control unit 7.

In the sense of the present invention, therefore, the application-relevant application data are held, managed and applied centrally in the hybrid management control unit 6. The other control units 9, 10, 11 and 12 of the electric motor portion of the drive-train are incorporated as neutral, application-independent control units in the motor vehicle control system according to the invention.

When the motor vehicle control system is operated for the first time, the hybrid management control unit 6 supplies all the neutral, application-independent control units 9, 10, 11 and 12 of the electric motor drive-train portion with the appropriate application data and for that purpose sends these application data with the help of defined data protocols and data services by way of the second data bus 8. The control units 9, 10, 11 and 12, of the electric motor drive-train portion, which are in themselves application-independent or neutral, therefore receive their application-dependent application data centrally from the hybrid management control unit 6.

Thus it is possible, in a motor vehicle control system for a motor vehicle with a hybrid drive, to incorporate neutral or application-independent control units for the electric motor portion of the drive-train, whereby on the one hand the complexity of data management in the control units and on the other hand the variety of control units to be kept in readiness for maintenance or servicing purposes, are reduced.

Exclusively in one control unit of the electric motor portion of the drive-train, namely preferably in the hybrid management control unit 6, a catalog of application data must be maintained and managed. All other control units of the electric motor portion of the drive-train receive their application data from the hybrid management control unit 6.

### Indexes

1 First data bus
2 First control unit/engine control unit
3 First control unit/brake management control unit
4 First control unit
5 First control unit/first diagnosis control unit
6 Hybrid management control unit
7 Transmission control unit
8 Second data bus
9 Second control unit/control unit for the electrical energy accumulator
10 Second control unit/power stage control unit
11 Second control unit
12 Second control unit/second diagnosis control unit

1-7. (canceled)

8. A motor vehicle control system, for a motor vehicle with a hybrid drive-train, comprising:
an internal combustion engine,
an electric machine,
first control units (2, 3, 4, 5, 6, 7) comprising at least one engine control unit (2) associated with the internal combustion engine of the hybrid drive, a transmission control unit (7) associated with a transmission and a hybrid management control unit (6), being connected to a first data bus (1),
second control units (6, 7, 9, 10, 11, 12) comprising at least the hybrid management control unit (6) and other control units (9, 10, 11, 12) of an electric motor portion of the drive-train, being connected to a second data bus (8),
a single one of the second control units connected to the second data bus (8) exclusively holds centrally application data for the hybrid management control unit (6) and for all the other control units (9, 10, 11, 12) of the electric motor drive-train portion, in order to supply application-dependent data to the other control units, and
in contrast the other control units of the electric motor drive-train portion, in themselves and unless supplied with data from the single one of the second control units, contain exclusively application-independent program data.

9. The motor vehicle control system according to claim 8, wherein the hybrid management control unit (6) and the transmission control unit (7) are connected to both the first data bus (1) and to the second data bus (8).

10. The motor vehicle control system according to claim 8, wherein the engine control unit (2), the hybrid management control unit (6), the transmission control unit, (7), a first diagnosis control unit (5), a brake management control unit (3) and at least one further control unit (4) of an internal combustion engine portion of the drive-train of the motor vehicle are connected to the first data bus (1).

11. The motor vehicle control system according to claim 8, wherein the hybrid management control unit (6), the transmission control unit (7), a second diagnosis control unit (11), a control unit (9) for an electrical energy accumulator of the hybrid drive and further control units (10, 11) of the electric motor portion of the drive-train of the motor vehicle are connected to the second data bus (8).

12. The motor vehicle control system according to claim 8, wherein the hybrid management control unit (6) centrally holds the application data for the hybrid management control unit (6) and for all the other control units (9, 10, 11, 12) of the electric motor portion of the drive-train of the motor vehicle, for supplying application-dependent data thereto.

13. The motor vehicle control system according to claim 12, wherein the hybrid management control unit (6) centrally holds the application data for supplying application-dependent data to all the second control units (6, 9, 10, 11, 12) connected to the second data bus (8), except for the transmission control unit (7).

14. The motor vehicle control system according to claim 12, wherein when the motor vehicle control system is first operated, the hybrid management control unit (6) supplies all the other control units (9, 10, 11, 12) of the electric motor portion of the drive-train with the application data and, for this purpose, sends the application data with the help of data services by way of the second data bus (8).

15. A motor vehicle control system for a motor vehicle having a hybrid drive train which comprises an internal combustion engine and an electric machine, the control system comprising:
a hybrid management control unit (6);
a transmission control unit (7) for controlling a transmission of the hybrid drive train;
a plurality of first control units (2, 3, 4, 5), the plurality of first control units comprising at least one engine control unit (2), for controlling the internal combustion engine of the hybrid drive train, and the plurality of first control units (2, 3, 4, 5) being connected to a first data bus (1);
a plurality of second control units (9, 10, 11, 12), for controlling an electric motor portion of the hybrid drive-train, being connected to a second data bus (8);
the hybrid management control unit (6) and the transmission control unit (7) each being connected to the first and the second data buses (1, 8); and
only a single one of the hybrid management control unit (6), the transmission control unit (7) and the second control units (9, 10, 11, 12) centrally holds application data for and supplies application-dependent data to all of the hybrid management control unit (6) and the second control units (9, 10, 11, 12), while a remainder of the hybrid management control unit (6) and the second control units (9, 10, 11, 12) exclusively contain application-independent program data.

16. A motor vehicle control system for a motor vehicle having a hybrid drive train which comprises an internal combustion engine and an electric machine, the control system comprising:
a hybrid management control unit (6);
a transmission control unit (7) for controlling a transmission of the hybrid drive train;
a plurality of first control units (2, 3, 4, 5), the plurality of first control units comprising at least one engine control unit (2), for controlling the internal combustion engine of the hybrid drive train, and the plurality of first control units (2, 3, 4, 5) being connected to a first data bus (1);
a plurality of second control units (9, 10, 11, 12), for controlling an electric motor portion of the hybrid drive-train, being connected to a second data bus (8);
the hybrid management control unit (6) interconnecting the first data bus (1) with the second data bus (8) and the transmission control unit (7) interconnecting the first data bus (1) with the second data bus (8); and
only a single one of the hybrid management control unit (6), the transmission control unit (7) and the second control units (9, 10, 11, 12) centrally stores application data for and supplies application-dependent data to all of the hybrid management control unit (6) and the second control units (9, 10, 11, 12), while a remainder of the hybrid management control unit (6) and the second control units (9, 10, 11, 12) exclusively store application-independent program data.
